(19) United States
(12) Patent Application Publication
(10) Pub. No.: US 2007/0126254 A1
(43) Pub. Date: Jun. 7, 2007

(54) Aerodynamic articulated motorcycle fairing

(76) Inventor: Charles Dominic Bugni, Cel Elum, WA (US)

Correspondence Address: Charles D. Bugni, 530 Taylor Rd., Cle Elum, WA, 98922, US

(21) Appl. No.: 11/653,452

(22) Filed: Jan. 16, 2007

(51) Int. Cl. B62J 17/04

(52) U.S. Cl. 296/78.1

(57) ABSTRACT

A motorcycle fairing comprised of plastic or composite material fabricated and assembled to compose a frame mounted fairing yoke together with upper and lower fork assembly mounted frontal sections, all having proximate parallel with one another, but perpendicular to the axis of rotation of the front fork assembly, which together form a smooth airfoil substantially enclosing the front wheel, fork assembly, headlight, and engine without substantial gap or opening, while allowing the front wheel to be turned laterally in the manner of a conventional motorcycle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTIING COMPACT DISC APPENDIX

Not Applicable

### BACKGROUND OF THE INVENTION—FIELD OF INVENTION

This invention relates to the field of motorcycle fairings, and specifically a means of combining into this invention and improving upon the superior aerodynamic efficiency, and subsequent increased fuel efficiency and performance characteristics attendant to the historical dustbin fairing (substantially enclosing front wheel and fork assembly) design found on road racing motorcycles in Europe of the historical period ranging from approximately 1953 to 1957 when said dustbin designs were relative common usage in competitive motorcycle road racing in, while incorporating the front fork lateral turning ability of existing fairing types legally suitable for operation upon public roads.

### BACKGROUND OF THE INVENTION

Existing motorcycle frontal fairings are designed to decrease the negative effects of aerodynamic drag upon the motorcycle and rider, thereby increasing, speed, efficiency, and/or rider comfort. However, all existing fairing types (prior art) suitable for public ‘road legal’ use are only marginally effective in achieving these goals owing to compromises made in aerodynamic efficiency, in order to accommodate turning of the motorcycle. As the purpose of the new invention is to dramatically overcome the aerodynamic limitations of existing fairings, but in a design also suitable for practical, everyday use—it is necessary to first describe the types of prior art in existence. These fairing types fall into two general categories, both of which encompass motorcycles designed for use on hard, smooth, street or track surfaces. The first general category will be identified as ‘road legal’, and which will contain motorcycle frontal fairings designed for legal use on public roads. The second general category will be identified as ‘specialty fairings,’ and will describe motorcycle fairings designed for competitive sport racing; speed record attempts; and fuel, efficiency, and general research testing

Beginning with the road legal category of motorcycle fairings, the types of frontal fairing found on motorcycles designed for legal use on public roads can be generally described as belonging to one of two types, dependant upon the location of the points of attachment used to secure the fairing to the motorcycle. These two attachment-point described types of categories can be described as either: in the first instance—the fork-mounted type; and in the second instance—the frame mounted type. In regard to initial invention, the frame mounted type has been common in the post World War II period, and the fork mounted type is most probably nearly as old as the existence of the motorcycle itself, having been a natural evolution from the first primitive motorcycle windshields known early in the twentieth century.

In the former fork-mounted type, the fairing is generally less expensive, more simple, smaller, and most notably—the fairing is attached to the front forks, and/or handlebar in a rigid fashion, as such as when the motorcycle operator executes a turn by rotation of the handlebar, this type of fairing turns laterally in concert with the front forks, handlebar, and front wheel assembly; and independently of the main frame of the motorcycle comprising the engine, drive assembly, rear wheel, fuel tank, etc. Although the fork-mounted type does provide some marginal degree of wind protection for the rider, the overall value of the fork-mounted fairing is negligible in terms of decreasing aerodynamic drag, and thus increasing efficiency and performance. Because the fork-mounted fairing is not affixed in the forward-most position on the motorcycle, but rather is located above and behind the exposed front wheel, brake(s), fender, headlight, and fork tubes—which together comprise the actual leading edge of the motorcycle into the oncoming air stream—the oncoming airflow encountered by the fork-mounted fairing is already turbulent, ‘rough’ air. Therefore any opportunity to establish a smooth, or laminar flow of air around such a relatively rearward mounted type of fairing are lost. Further,as the distance between the rear portion of the fork-mounted fairing and the upper torso and head of the rider is a relatively large one—the resultant gap leads to yet more turbulent air which not only reduces the efficiency and performance of the motorcycle, but also increases the buffeting, noise, and general discomfort experienced by the rider.

The second general type of fairing used on road legal motorcycles—the frame-mounted fairing, is attached rigidly to the main frame of the motorcycle, and thus when the motorcycle operator executes a turn by rotation of the handlebar, the fairing does not turn laterally with the front forks, handlebar, and front wheel assembly. As in the fork-mounted type described above—the principal functions of the frame mounted fairing are to decrease the aerodynamic drag and its effects upon the motorcycle and the rider/operator, thus increasing the performance and efficiency of the motorcycle, while simultaneously increasing the wind and weather protection for the rider.

Unlike the handlebar-mounted type fairing which is mounted above and somewhat behind the leading edge of the front wheel—the frame-mounted type, although also located above and behind the leading edge of the front wheel—the frame mounted type additionally encloses some of the lower portions of the main frame of the motorcycle, often including the engine, transmission, and portions of the engine air intake and exhaust components.

However, like the handle-bar mounted type, the frame mounted type also does not enclose the aerodynamic leading edge of the front wheel, forks, and brake assembly which encounter the oncoming headwind. Nor does either of these types cover more than a very small fraction (if any at all) of the area of the total lateral diameter of the front wheel and tire assembly, This lateral area being the total circular area of the combined front wheel assembly visible when said assembly is viewed from either side of the motorcycle.

Although in most cases a fender (also known as a mud-guard) does cover a portion of the exterior circumference of the front wheel and tire assembly, the portion of the total lateral area of front wheel and tire assembly that is covered by the fender is marginal (if any at all), and if any aerodynamic drag reduction does result from the shape of the fender, it is generally incidental to the intended primary function and design of the front fender which is to protect the motorcycle engine components, and rider from foreign objects and water propelled upward as the result of the rotating front tire's interface and contact with the road surface, and foreign object thereupon. Although in a few instances of road legal motorcycles, some fenders or mud-guards have been designed with some very small degree of aerodynamic efficiency in mind, in no case are the fenders an integral part of the fairing itself, but rather a completely separate part or component.

Although generally covering a larger area of the motorcycle, than the fork-mounted type; as the frame-mounted type of fairing does not extend to, or cover the front wheel, brake, fender, and fork assembly—these latter components again act as the leading edge of the motorcycle into the oncoming air stream. Therefore although the frame-mounted type of fairing may provide a somewhat decreased level of aerodynamic drag when compared with the fork-mounted type, or the motorcycle sans any fairing—like the fork-mounted type—the rearward leading edge of the frame-mounted type again results in the airstream that encounters the fairing to be a turbulent, rough airflow that again makes smooth or laminar airflow over the fairing virtually impossible. Although it is true that the frame-mounted type does generally provide better aerodynamic drag reduction as compared to a fork-mounted type, or motorcycle without any fairing at all—it is still only a marginally efficient aerodynamic shape due to the fact that the leading edge of the entire vehicle is comprised of the rough and irregular shapes and edges of the front wheel, brake, fender, and fork assembly. In terms of aerodynamic efficiency then, the shape of the leading edge of any airfoil is critical—thus the rough and irregular shapes of the leading edges of the motorcycle, cannot be efficiently overcome to any large degree, no matter how smooth the frame-mounted fairing exists over the medial and posterior parts of the motorcycle. In other words, the front wheel, brake, fender, and fork assembly of a motorcycle must be wholly or substantially enclosed to attain the most of aerodynamic drag reduction benefits.

In addition, as the rider needs to laterally rotate the handlebars in order to negotiate turns in direction of the vehicle, the frame mounted fairing must have cutouts or gaps in its surface behind and in front of each end of the handlebar to allow the forward movement of the handlebar end in alternative fashion as the vehicle is turned to either the left or right. Further, as these cutouts must allow adequate clearance for the hands and lower arms of the rider, this part of the smooth surface area of the faring, immediately behind the leading edge of the fairing that must be removed can be fairly substantial, thus increasing aerodynamic drag, while simultaneously exposing the rider's hands and lower arms directly into the oncoming air stream.

The frame-mounted type fairing is also further designed to allow for the flow of the oncoming airflow to contact the engine fluid cooling units, in the form of both the coolant radiator, and/or the engine oil cooler, at an angle of attack which is directly perpendicular to the direction of travel of the motorcycle and the resulting oncoming airflow. Although this does allow for maximum cooling efficiency of the radiator and/or engine cooler, it also dramatically the aerodynamic drag effect upon the vehicle, thus reducing overall efficiency and performance. An analogous example in nature which approximates the frame-mounted fairing would be the salmon. If one envisions a healthy salmon traveling up a river into the current, one can easily appreciate the smooth, efficient sleek design of the body of the fish. If one were to then imagine the salmon swimming up the same stream into the same current—but now with its mouth wide open—one can appreciate both the effect upon the progress of the fish (or the similar shape of a motorcycle equipped with a frame mounted fairing), when the very efficient latter portion of the body of the fish (or said motorcycle), is largely negated by the blunt open mouth.

Turning to the Specialty category of motorcycle fairings as opposed to the road legal types described above—these special types of fairing can be differentiated and categorized into two basic types, with the determinate criteria not being the method of attachment (as is the case with the road legal type) but rather by the degree or amount of the motorcycle which is either partially or fully enclosed by the respective fairing type.

The first of these two types is commonly known as the streamlined, or fully enclosed type. This type of fairing usually is constructed as a single fully enclosed body, which resembles, and is constructed similarly to that of a modern low drag/high speed aircraft fuselage. In this type, the outer surface or skin of the fairing is generally cylindrical in shape, with only small openings at the front and rear wheel locations of the motorcycle to allow for minimal, vertical protrusion of the front and rear wheels to a distance minimally sufficient for clearance of the lower main body of the fairing from the ground surface. Additionally, small holes or openingsmay exist for engine cooling, intake, or exhaust functions. A small aircraft style enclosed canopy, or aerodynamically designed open-topped windscreen is usually also incorporated into the fairing's upper surface, to allow the operator a visual portal to control the vehicle, while also minimizing frontal surface area. This type of fairing is used almost exclusively for competitive speed record attempts, wherein the vehicle is not required to make any significant turns, but rather travel only in a straight line, at the highest possible speed. As the design of this type of fairing is designed for maximum aerodynamic reduction, but is not concerned with the turning necessary of practical everyday transportation, it can be, and is made as narrow as possible, with the rider being fully enclosed within the fairing after entering the vehicle through a door or moveable panel, which is located on the top or side of the fairing. Therefore although this type of fairing is truly very aerodynamically efficient, the inability of the front wheel to turn laterally, to any practical degree, combined with the inability of the rider to extend his legs and feet outside the vehicle when coming to a full stop—render this type of fairing essentially useless for public road or practical use.

The second of these special fairings, is commonly known as the dustbin fairing. The name of which traces its origin to the decade of the 1950's, wherein the fairing's appearance (when viewed from the side), strongly resembled the shape of the common dustbin with handle, used domestically as a household tool in conjunction with the common broom, to remove floor sweepings. The most apparent, and defining characteristic of the dustbin style fairing, it the shape of the front of the fairing, which substantially encloses the front wheel and tire assembly, with the fairing attached. This type of fairing was used from approximately 1953 until 1956 in closed course motorcycle road racing, principally in Europe, and most notably in Grand Prix motorcycle racing circuit, until the dustbin was banned in European competition by the sanctioning body of those events. In addition to the substantial enclosure of the front wheel and tire assembly, the dustbin fairing was attached to the motorcycle by attachment points located on the main frame of the motorcycle, and protruded forward from the main frame to enclose most of said front forks, wheel and tire assembly. As such the dustbin fairing was not directly attached to the front forks or handlebars of the motorcycle, but rather frame mounted in the same fashion as the previously described road legal frame-mounted type.

Although this configuration allowed some lateral turning of the front forks and wheel and tire assembly by laterally rotating the handlebar, such turning was limited to only a few degrees of rotation to either the left or right, as the enclosed wheel and tire assembly, as well as the handlebar and front forks, would come into almost immediate contact with the interior of the sides of the frontal portion of the fairing encompassing the front wheel, which severely limited the ability for the rider to execute any turn of more than a few degrees, thus rendering the motorcycle equipped with the fairing to be extremely difficult to use for any purpose other than competitive road racing, and thus inconvenient and wholly unsuitable as a means of practical transportation. Further in an effort to provide these dustbin fairings with this small degree of ability to turn, a large opening or hole would be incorporated to allow the front wheel to turn laterally. Although this did marginally allow for some ability to turn the motorcycle laterally—the opening itself allowing such movement, was itself a deleterious to the dustbin design, as the opening greatly increased drag and turbulence on the under side of the fairing, as smooth, laminar airflow over the nose of the fairing became turbulent, rough air upon encountered the large gap found to either side of the front wheel, brake, fender, and fork assembly, on the bottom of the fairing. Like the afore mentioned frame-mounted fairing found on the road legal motorcycle the dustbin fairing requires large cutouts in the fairing surface directly in front of the handlebar ends to allow for turning of the motorcycle. Thus again, a large gap in the smooth fairing surface acts to increase aerodynamic drag, and therefore reducing efficiency and performance, while at the same time decreasing rider comfort and protection.

A final characteristic of the dustbin fairing which is notable, was the effect of cross winds upon the stability of a dustbin equipped motorcycle, especially at high speed. As the dustbin fairing's surface area extended forward of that of the non-dustbin frame-mounted, fairing—the location of the center of pressure resulting from a crosswind blowing laterally from a perpendicular direction upon the dustbin fairing, would more forward, than that of the location of the center of pressure on a non-dustbin motorcycle fairing. However, because of the relatively light weight of the dustbin fairing in relation to the combined weight of the motorcycle and rider, a the lateral aerodynamic center of pressure is moved forward, while the center of mass of the total weight of the vehicle did not move forward to a corresponding amount. Therefore the front of the dustbin fairing equipped motorcycle has an increased tendency to be turned away from the intended straight-line direction of travel, in a lateral fashion, in direct reaction to, and as a direct result of the crosswind imparting a moment of force upon the more forward located, lateral center of aerodynamic pressure found in the forward extending dustbin type. This last characteristic resulted in the dustbin style fairing being harder to control in windy conditions than either non-dustbin style fairing equipped motorcycles, or motorcycles without any fairings. Thus the dustbin type fairing was generally thought to be more dangerous to use in racing conditions in any type of intemperate weather, which contributed to its exclusion from competitive racing in Europe.

### BACKGROUND OF THE INVENTION—OBJECTS AND ADVANTAGES

The overall objectives of the invention described in this patent are to reduce the negative effects of aerodynamic drag upon the motorcycle and rider for the purpose of increasing the fuel efficiency and performance of the motorcycle, while simultaneously increasing the comfort and safety of the rider. More specifically, the objects and advantages of the present invention are to provide aerodynamic drag reduction superior to that of the historical frame-mounted dustbin fairing, which encloses the front wheel and fork assembly, and also that of motorcycles with existing frame-mounted fairings, by additionally improving the aerodynamic efficiency and safety over that of the historical dustbin fairing; while also providing the necessary and practical, lateral turning ability of motorcycles equipped with only fork-mounted fairings—by the following objects and advantages of the present invention:

To provide the superior aerodynamic leading surfaces attendant to the enclosure of the leading edge of the front wheel and fork assembly and handlebar, by aerodynamically efficient upper and lower frontal fairing sections attached directly to the front fork assembly, with a frame mounted fairing extending to form a yoke around the front fork assembly and sides of the motorcycle, between the upper and lower frontal fairing sections without significant gap or spacing.

to provide for the placement of a radiator(s) in and flush with the surface area of the frontal portion of the frame mounted fairing yoke substantially above the front wheel; to preclude the need for a large opening in the fairing formerly required for engine cooling in more conventional frame mounted fairing types, thus decreasing aerodynamic drag.

to provide the ability for the rider to execute a turn of the motorcycle to a degree found on any other road legal motorcycle, equipped with or without a fairing. By mounting the frontal fairing portions only to the front fork assembly, and by positioning the above noted frame mounted fairing yoke top and lower vertical edges to the opposing vertical edges of the frontal fairing sections, and by shaping these edges to be positioned perpendicular to the axis of rotation of the front fork assembly, and thus allowing the frontal sections—when the rider rotates the handle bar laterally to execute a turn—to freely rotate independently of the frame mounted fairing yoke, and to return to their original positions with the frame mounted fairing yoke section once the handle bar is returned to its original position allowing a straight forward direction of travel of the motorcycle, thereby allowing the rider to execute any turn, with full freedom of lateral rotation of the handlebars in either direction.

and to further provide that ability to turn without the large lateral hole or opening found on the bottom of the historical dustbin fairing located to both sides of the front wheel, which is eliminated in this invention by the fairing sections enclosing the front wheel and handlebar, being mounted only to the front fork assembly, thus turning in common laterally with the front fork and wheel assembly, thus allowing for very close lateral spacing between the front wheel and the fairing, which again results in a more aerodynamic and efficient surface.

to provide increased linear stability of the motorcycle from the effects of crosswinds, by moving the center of mass of the motorcycle forward by utilizing the void created by the fairing enclosure above the front wheel, to install auxiliary motorcycle components such as the battery, headlight, toolkit, radiator, and cooling fluid reservoir, this alternately would have the effect of increased linear stability of the motorcycle in crosswind conditions by moving the lateral center of air pressure rearward in relation to the lateral center of mass, and thus creating a weather vane effect, wherein the center of lateral air pressure, having moved further to the back of the motorcycle in relation to the center of mass, thus resulting in cross winds having a tendency to push the rear of the motorcycle downwind from the front of the motorcycle, thus at least partially negating the effect of crosswinds upon the lateral direction of the front of the motorcycle,

to provide improved lateral stability and cornering adhesion of the front tire, by moving the location of the auxiliary components noted above, from the more customary rearward mounting locations to the more forward area within the spatial void created there by the semi-circular ascending curve of the top of the frontal portion of the fairing approximately above the front wheel.

to provide further increases in the aerodynamic efficiency of the fairing by incorporating the front turn signals into the surface and contours of the fairing;

to provide superior wind and weather protection for the rider, and especially for the rider's hands and upper body;

to provide reduction of wind buffeting and noise, by the superior smooth aerodynamic shape of the invention over the rough exposed surfaces created by the many forward-located components not enclosed on other types of motorcycle fairing;

to provide increased front wheel traction and stability by increasing aerodynamic dow forces upon the front wheel of the motorcycle, while reducing the transfer of weight upon the rear wheel caused by the effect of a reduction of oncoming wind striking the upper body of the rider and being transferred to the rear wheel.

to increase storage area by using that space under the seat that is most commonly used for items such as the battery and took kit from that traditional location under the seat of the motorcycle, thereby creating an additional storage space.

### BRIEF SUMMARY OF THE INVENTION

A motorcycle articulated fairing consisting of two fork mounted frontal sections which together with a frame mounted fairing in the form of yoke, combine to form a fairing shaped to substantially enclose the front wheel, front fork assembly, and engine of the motorcycle, thus providing substantial aerodynamic protection for the rider along with the aerodynamic advantages superior to the aerodynamically efficient, historical dustbin fairing. This is achieved by shaping the edges of all three fairing portions, at the position where all three come together approximate to the front fork assembly, at an angle perpendicular to the axis of rotation of the front fork assembly. In addition, as the handlebar and fork assembly rotate laterally in common with the fairing frontal sections, the aerodynamic efficiency of the present invention is further improved over that of either existing frame mounted fairings and or dustbin fairing types by the elimination of large voids designed into the sides of both dustbin and existing frame-mounted fairing types, required for end clearance of the handlebar when turning laterally for low speed sharp turns. Further, by mounting the engine cooling radiator(s) either in, and flush with the surface of the side mounted fairing panels, or inside and parallel to the outer surface of said side panels, the inefficient air intake holes formerly necessary for engine cooling in the historical dustbin design can also be eliminated. Most importantly to allow the motorcycle equipped with the fairing comprising the invention can to be turned in either direction in a manner similar to that required of a motorcycle without any fairing, or a motorcycle equipped with an existing fork or frame mounted fairing type. Finally by using the large void created within the shape of the frontal section enclosure, located above the front wheel, to relocate some of the motorcycle components, the center of mass of the motorcycle moves forward, distributing more weight upon the front wheel thus increasing control, safety, efficiency, and convenience for the rider.

### BRIEF DESCRIPTION OF THE DRAWINGS

FIG. 1. on drawing 1/5 is a view of the prior art described in the text of the background of the invention as belonging-to the category of road legal motorcycles; and is a perspective view example of a motorcycle with a frame-mounted fairing type;

FIG. 2. is a perspective view example of a fork mounted fairing showing only the fairing and the frontal portion of a motorcycle to which it is attached.

FIG. 3. on drawing 2/5 is side view of an example of the streamlined type as described in the text of the background of the invention as one of two types belonging to the specialty category.

FIG. 4. is a side view of an example of the historical dustbin fairing as again described in the text of the background of the invention as the second type of fairing in the specialty category.

FIG. 5. on drawing 3/5 is a side view of a motorcycle with the embodiment of the invention. Specific items referenced by number on FIG. 5. and also on FIG. 6-12 are as Follows:
1.—denotes the location of the frontal exterior of the lower front fairing section mounted to the front fork assembly.
2.—the frame mounted yoke shaped fairing on the motorcycle, with elements of the motorcycle frame, and interior attachments visible.
3.—denotes the upper fork frontal fairing section mounted to the front fork assembly.
4.—the locations on the fork mounted yoke shaped fairing where the rear attachments affix said fairing to the frame of the motorcycle.
5.—the locations at which the forward attachments connect the side of the fairing yoke shape to the main frame of the motorcycle near, and just below the headstock of the motorcycle frame.
6.—The headstock of the motorcycle frame, allowing the front fork assembly to rotate, which is also positioned to form the angle of the axis of rotation for the front fork assembly.
7.—represents the locations on the left and right sides of the front lower fairing section is attached to the un-sprung portion of the front fork tubes by means of a bracket affixed to a circular compression clamp.
8.—represents the approximate left and right locations of the frontal side portions of the frame mounted fairing yoke where radiators could be affixed flush with the surface of said fairing surface.

FIG. 6. is a perspective from above and slightly behind the motorcycle with the upper and lower frontal fairing sections and fork assembly turned to the left. All lettered items are as described above in paragraph 37.

FIG. 7. is again a perspective from above and slightly behind the motorcycle with the upper and lower frontal fairing sections and front fork assembly in a straight ahead position.

FIG. 8. is another view from a perspective from above and slightly behind the motorcycle with the upper and lower frontal fairing sections and front fork assembly, turned to the right.

FIG. 9 on drawing 4/5 is an incomplete view of the motorcycle and the frame mounted yoke fairing section from a perspective above and in front of the motorcycle showing the general relationship of the said section to the main portion of the motorcycle, behind the headstock of the motorcycle frame, and without the front fork assembly shown.

FIG. 10. is a more detailed view, principally of the interior of the side of the frame mounted yoke fairing section from a perspective of above and slightly forward and to the right of said portion of the fairing section with emphasis on 4. the attachments near the rear of the interior of the side panel; 5. the location of the attachments which would be affixed near the headstock on the frame of the motorcycle.

FIG. 11. is a frontal view of the motorcycle with emphasis upon the approximate positioning of both the upper and lower fork mounted fairing sections and the frame mounted yoke fairing section, relative to one another.

FIG. 12. is a dissected view of the left front portion of the area as emphasized on the front view of the motorcycle and the invention in FIG. 11., and a cut-away view of that portion of the main spar of the motorcycle frame approximately at the headstock of the motorcycle frame, labeled as 6.

FIG. 13. is the type of bolt, known as the button head type, which along with a self-locking type threaded nut, is to be used in this embodiment of the invention to connect the lower frontal fairing section to the fork clamp brackets in FIG. 14 below, in the case of the frontal fairing section; and to the attachments numbered 4 and 5, connecting the frame mounted fairing yoke to the motorcycle frame.

FIG. 14. represents a right and left side metal bracket to be mounted on both the right and left un-sprung portion of the front fork tubes, for the purpose of attaching the lower frontal fairing section. In this embodiment, the brackets would be curved to conform to the interior surface of the lower front fork mounted fairing section.

FIG. 15. shows a transparent view of the position in which both upper and lower attachment brackets would be located in regard to both the fork tubes and the lower frontal fairing section; and the handlebar and the upper fairing section respectively.

FIG. 16. is an illustration of two radiator sections which would be positioned and attached to the frontal, side portions of the frame mounted fairing yoke in an manner flush with, or just inside and parallel to the exterior surface thereof.

FIG. 17, denotes the compression clamp brackets attached directly to the handlebar at the top of the front fork assembly and utilized for the attachment of the upper front fairing section, number 3, as shown in FIGS. 5-9, 11, and 15. However, in other embodiments this upper fairing half could be attached to the front fork or triple clamp assembly directly.

### DESCRIPTION OF THE PREFERRED EMBODIMENT

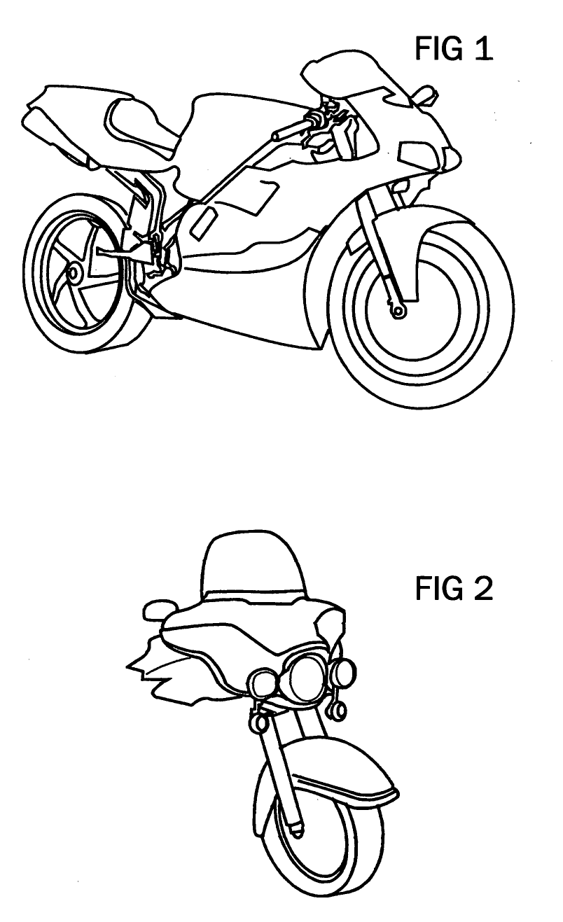

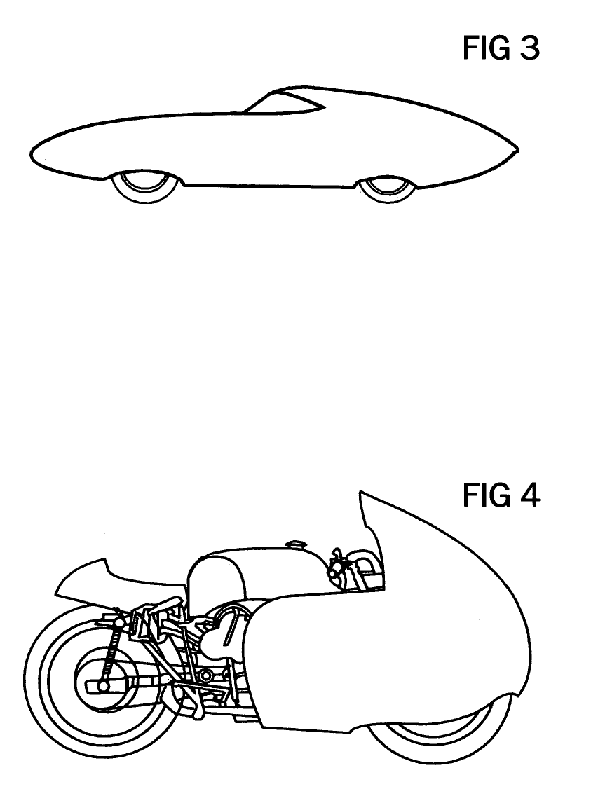

For the purpose of understanding and promoting the principles of the invention reference will be made to the embodiment illustrated in FIGS. 5 through 12 which appear on drawing pages 3/5, and 4/5, and specific terms will be used to describe same. It should also be understood that no limitation on the scope of the invention is hereby intended by these drawings of the preferred embodiment in regard to the principles of the invention, as other alternative embodiments not shown in said drawings are possible and shall be indicated at the salient points in this description. None of the drawings as represented in FIGS. 1 through 16 are to an exact scale, as several of the views of the drawings are drawn from somewhat unusual perspectives in order to aid in a better understanding of the principles of the invention.

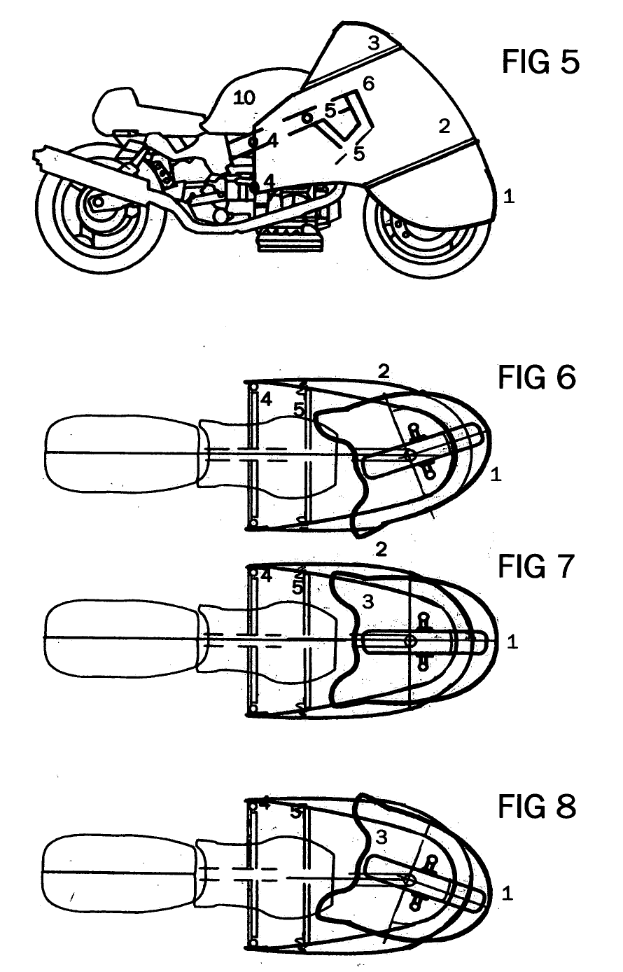

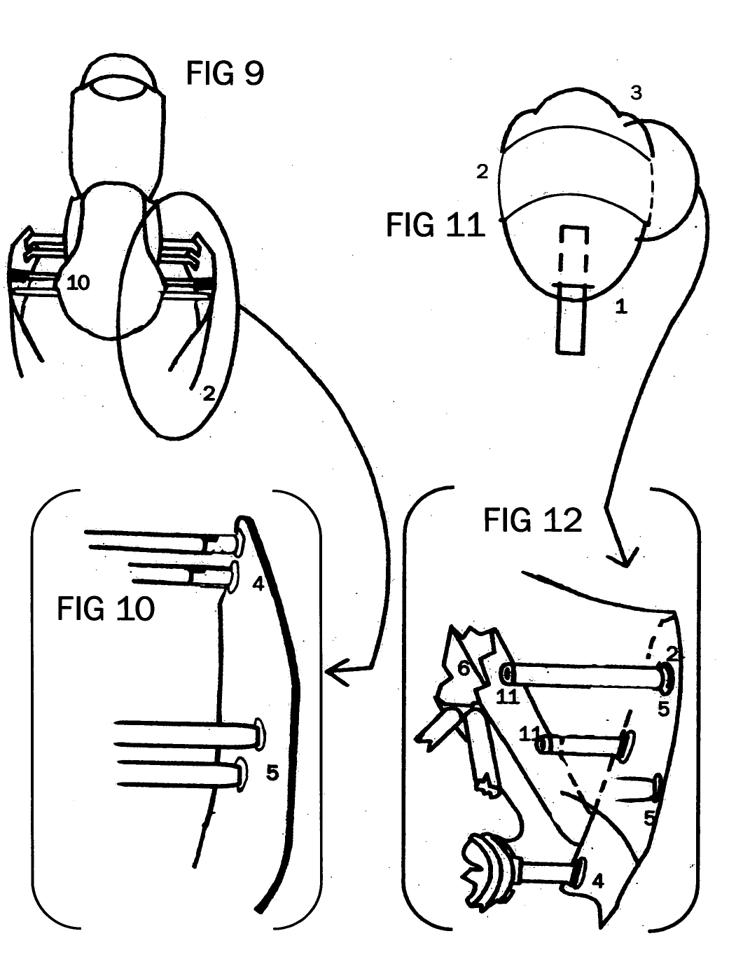

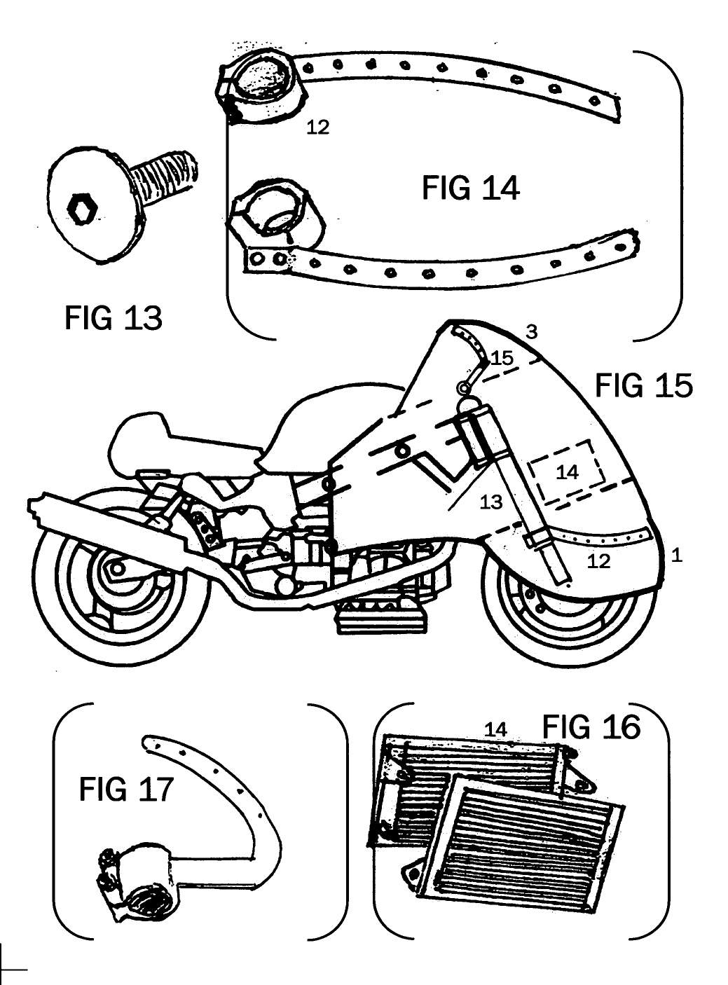

To further aid in the understanding of the principles of the invention, FIGS. 1 through 4 on drawings 1/5 and 2/5 represent the four types of motorcycle fairing prior art as earlier described in the background of the invention. Particularly noteworthy are FIGS. 1 and 2 which show examples of the frame-mounted fairing, and the fork-mounted fairing respectively, and FIG. 4 which is a side view of the dustbin type of fairing, historically used in racing in the 1950's. These existing prior art examples are relevant as the present invention shares functional elements with of all three types.

Referring to the lower frontal fairing section, number 1, as shown in FIGS. 5-8, 11, 12, and 15 the fairing may be constructed of left and right side portions. Both left and right portions of the lower frontal fairing itself can be molded out of an adequately rigid plastic material or by means of various layering composite materials, using any one of a number of fiber types in combination with epoxy or resin materials. However for the preferred embodiment, the lower front fairing section, and the upper fairing section, number 3, FIGS. 5-8, 11, and 15, will be constructed out of combination of glass fiber and resins layered to create a single portion, in the case of the upper front fairing section, number 3, and a left and right portions, in regard to the front lower fairing section, number 1. Likewise the frame mounted fairing yoke as shown as 2 in FIGS. 5-9, 11, and 15, can be constructed in a similar manner, using the same steps as listed below for the frontal fairing section portions. However, the frame mounted fairing yoke section will be constructed in a three portions. In regard to each portion of the above noted fairing sections, a separate plug must first be constructed to provide the shape of the desired fairing section part, and subsequently mold must constructed from same, to be used for the final construction of the portions making up each fairing section.

In other embodiments of the invention, an additional clear windscreen or shield could be formed by molding a sheet of adequately rigid, transparent plastic sheet material, and affixing same to the upper front fork mounted fairing section, number 3. However, as such an addition is more esthetic than functional, in this embodiment, said clear shall be omitted, and that portion where said windscreen or shield would be located, shall simply be an elevated portion of the upper frontal fairing section, number 3.

To construct the template for the fairing portion molds, a plug must first be constructed for each by, in this embodiment, tracing onto plywood sheets (although other sheet materials could also be used) the outline of the various layers or stations of the horizontal cross section of the proposed shape of each of the fairing section portions, and then by cutting out same to form horizontal plywood stations. Repeating the process by tracing out and cutting the desired vertical shape of the desired fairing section portions, a base plate or armature is created, to which the afore mentioned horizontal stations can be attached at right angles. Once said horizontal stations are attached to the base plate a ribbed template will result, but with gaps existing between the horizontal stations, parallel to one another once the horizontal stations have been attached to the vertical base plate at right angles. These remaining gaps between the stations must be covered over and filled in to create the skin or surface of the plug. Again, this can be accomplished in a number of ways, but for the preferred embodiment, a grid of wire screen is stretched over the plywood template and stapled in place. This wire screen is then covered with an automotive type body filler, normally used for auto body repair. This material can be troweled over the surface of the wire screen, and can be rasped or grated to approximate the desired shape one the product, as the product begins to harden as per the manufacturer's directions, or additional body filler can be added as needed to achieve the shape desired. Later additional grating, sanding, or polishing, or spot application of more filler where needed, can be done to perfect the exact shape desired.

When constructing the plug and subsequent final mold to be used to form the desired fairing portion shapes, additional over-lapping tabs, or flanges should be designed into the edge of the fairing section portions, where same will meet other adjoining portion of the same fairing section, to facilitate the interconnection of the fairing section portions to complete each fairing section. At these overlapping tabs or flanges, threaded bolts, FIG. 13, combined with self locking nuts will attach the portions securely together to complete each respective section. These tabs or flanges should be slightly offset on one of the fairing sections, to a depth below the eventual external surface of the finished fairing section, to a depth of the thickness of the fairing section fiberglass material, or skin, to allow for the eventual combined joint between to fairing section panels to form a smooth external surface.

After completion of the plug, laying out and completion of the actual fairing section portion forms, and final completion of the fairing section portions themselves, same will be affixed to the metal attachment points by use of the threaded large headed bolts as shown in FIG. 13, and threaded self locking nuts.

Referring now to FIG. 5, there is shown a side view of the completed fairing invention mounted upon a motorcycle. The number 1, located just to the right of the invention, denotes the fork mounted lower fairing section, also seen in FIGS. 5-8, 11, and 15., which is mounted upon and affixed to the front fork assembly and thus can turn in concert to the left or right as one unit, with the front fork and wheel assembly. Number 2 on FIGS. 5-8, 11, and 15, denotes the frame mounted fairing yoke section which in this embodiment is constructed of fiberglass, although plastic or other composite materials could also be used. FIG. 5, number 2, also represents the rearward portion of the frame mounted fairing yoke section as transparent, in order to demonstrate the locations of other components of both the invention and the motorcycle in this embodiment, which would not normally be visible from the exterior of the motorcycle with the invention in place. Also on FIG. 5, both locations of number 4, represent the approximate positions of the attachments, in this embodiment which are located and affixed to the interior surface of the side of the frame mounted fairing yoke section, and comprised of posts of metal tubing extending to the proximal, or inward attachment points on the frame, or the engine casing, and affixed at those points by means of threaded bolt, FIG. 13, and self locking nut, to the frame, or by threaded bolt or screw, if attached to the engine casing. Both posts of metal tubing upon which the fairing sections are attached, are formed by welding, stamping or forging, and would vary slightly in overall length, as their respective attachment points on the proximal, or motorcycle-frame end, would vary in length because of the need to have said fairing section attachments located above and below one another to allow a more or less parallel and vertical position of the side of the frame mounted fairing yoke section, in relation to the midline, or direction of travel of the motorcycle.

The approximate locations of the attachments with numbered as 5 in FIGS. 5-8. 11, and 15, which in this embodiment are also two posts, again comprised of metal tubing located on each side of the motorcycle, with a right angle welded, stamped or forged tab with a bolt hole attached by threaded nut and bolt connection directly to the frame of the motorcycle, FIG. 12, number 11. In other embodiments, the attachments could also be affixed to the frame by circular, square, or rectangular clamp. The upper of these two attachments shown as number 5, is located upon the main beam or backbone of motorcycle frame near the headstock of the frame, and just under the customary location of the fuel tank. The second lower post comprising the lower attachment also shown as number 5, would be of the same configuration and affixed again by threaded nut and bolt to the motorcycle frame, upon in the embodiment, the lateral metal bracing of the frame which extends down and rearward to support and connect the engine of the motorcycle to the frame. At all points described and represented as numbers 4 and 5, both posts of metal tubing would have an smooth metal disk welded, stamped or forged to the outer edge of the post which would be of larger surface area that the cross section of the area of the post itself, to provide a broader contact point for the interior of the side of the frame mounted yoke fairing section, and which would provide a larger contact surface area between said fairing section and the connection posts of metal tubing.

FIGS. 5-9, 11, and 15, number 2 denotes the frame mounted fairing yoke section of the invention.

FIG. 5, number 6 shows the approximate location of the headstock of the frame of the motorcycle and also represents the axis of rotation for the front fork assembly.

In FIGS. 5, and 9, number 10 represents the fuel tank in the position it is most usually found in most motorcycles, and is illustrated only for the purpose of reference.

FIGS. 6-8 are not to scale, representations of the invention attached to a motorcycle and viewed from a perspective above, and somewhat behind the motorcycle, in order to allow a view looking down, and parallel to the axis of rotation of the front fork assembly, wheel, and frontal fairing section.

Number 4 on FIG. 6-8 also shows a simplified arrangement of the attachments upon the interior rear portion of the side of the frame mounted yoke fairing section. In order to allow free rotation of the fork mounted upper and lower front fairing sections and to eliminate binding between said sections and the frame mounted yoke fairing section, all fairing section edges should be constructed and positioned parallel to one another at their points of intersection with one another, proximate to the front fork assembly, and said edges should also be uniformly perpendicular to the axis of rotation of the front fork assembly.

Owing to the distortion of the invention represented by the above described perspective, number 5 on FIG. 6-8 is represented only by a single illustration of the attachment, which in this embodiment is the above described metal tubing post, and attached to the motorcycle frame on the proximal, or frame end of the post, by a threaded bolt and self locking nut, and attached to the interior of the frame mounted yoke fairing section at the distal, or fairing end of the attachment post of metal tubing.

FIG. 6-8 also show the dynamic relationship between the frame mounted yoke fairing sections and the fork mounted upper and lower frontal fairing sections and front fork assembly, as the front fork assembly, front wheel, and fork mounted upper and lower fairing sections are shown turned to the left, center, and right.

FIG. 9. is a view from above and forward of the motorcycle, of the relative relationship of the frame mounted fairing yoke section to the motorcycle, but without the front fork assembly, wheel, or frontal fairing section. In addition emphasis upon the left portion of same is shown below in FIG. 10.

FIG. 10 is again a viewpoint above and forward of the side of the fairing yoke section, with number again 4 denoting the approximate location of the rear attachments in this embodiment, as they are located near the rear of the side yoke fairing section, but with one substantially located over the other in vertical fashion. Both these attachments are again mounted to the motorcycle via posts, with the upper being attached directly to the main spar, or backbone of the frame of the motorcycle by threaded bolt and locking nut, and the lower being attached to the engine-transmission casing by threaded screw, utilizing an existing connection point designed for assembly of the motorcycle engine and its components. Number 5 again denotes the two metal tubing posts which are attached by threaded bolts directly to the motorcycle frame approximately, but not exactly above and below one another.

FIG. 15 is a transparent side view of the motorcycle, with the front forks shown in relation to the invention and the headstock of the motorcycle. The front forks, number 13 are shown in their position parallel with the semi-vertical position of the headstock of the frame of the motorcycle, and together with same, comprise the angle of the axis of rotation for the front fork assembly, front wheel, and upper and lower front fork mounted fairing sections, numbers 1 and 3. Also shown as number 12, is the position of the circular compression clamps with curved brackets, which affix the frontal lower fairing section to directly to the un-sprung portion of the upper, external fork tubes as shown. This attachment being done by the use of threaded bolts as shown in FIG. 13, in combination with self locking threaded nuts, positioned through holes in both said bracket and fairing section, pre-drilled to intersect with one another for proper positioning of said fairing section.

FIG. 16 represents two independent radiators which can be attached parallel to, or just inside of the surface of the forward, side portion of the frame mounted yoke fairing section, at the approximate point shown as number 14.

FIG. 17 denotes a compression clamp with welded, bolted, forged, or stamped curved bracket arm, with pre-drilled holes, which would be directly attached to the handlebar, and by use of threaded bolt, FIG. 13, and self locking nut, to attach the upper front fairing section to the front fork assembly at the location as shown on FIG. 15, as number 15. However, on other embodiments of this invention, said upper fairing could be affixed directly to the front forks, or front fork assembly.

I claim:

1. a motorcycle fairing comprising and upper and lower frontal fairing sections attached to the front fork assembly and extending horizontally at the widest point to the approximate width of the handlebar, and with the upper section extending vertically to a point above the top of the front fork tubes, and with the lower section substantially enclosing the front wheel and front fork assembly, and with the upper portion having a lower vertical edge, and the lower portion having an upper vertical edge, perpendicular to the axis of rotation of said front fork assembly, and
located substantially between and behind said sections, a separate frame mounted fairing forming a yoke, around the front of, and on each side of the motorcycle, with upper and lower frontal vertical edges of said fairing parallel to those of the most proximate edges of the frontal fairing sections noted above, and also perpendicular to the axis of rotation of the front fork assembly, thereby substantially enclosing in a single airfoil, without substantial gap or void between the fairing sections, the front wheel and fork assembly, handlebar, and engine of the motorcycle, with full lateral rotation of the front upper and lower fork sections and fork assembly, independent of the frame mounted fairing section forming a yoke.
